(19) United States
(12) Patent Application Publication
(10) Pub. No.: US 2008/0248692 A1
(43) Pub. Date: Oct. 9, 2008

(54) Extended Memory Card and Manufacturing Method

(75) Inventors: Jim Chin-Nan Ni, San Jose, CA (US); Abraham Chih-Kang Ma, Fremont, CA (US); I-Kang Yu, Palo Alto, CA (US); Ming-Shiang Shen, Hsin Chuang (TW)

Correspondence Address: LAW OFFICES OF IMAM, 111 N. MARKET STREET, SUITE 1010, SAN JOSE, CA, 95113, US

(73) Assignee: SUPER TALENT ELECTRONICS, INC., San Jose, CA (US)

(21) Appl. No.: 11/933,104

(22) Filed: Oct. 31, 2007

Related U.S. Application Data
(63) Continuation-in-part of application No. 11/864,696, filed on Sep. 28, 2007.
Application No. 11/864,696 is a continuation-in-part of application No. 10/854,004, filed on May 25, 2004.
Application No. 10/854,004 is a continuation-in-part of application No. 10/708,172, filed on Feb. 12, 2004, now Pat. No. 7,021,971.
Application No. 10/708,172 is a continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 11/929,957, filed on Oct. 30, 2007.

(51) Int. Cl. H01R 13/648; H01S 4/00

(52) U.S. Cl. 439/607; 29/592.1

(57) ABSTRACT

An embodiment of the present invention includes an extended memory card comprising memory circuitry, extended memory controller circuitry, a plurality of first format connection fingers, and a plurality of second format connection fingers. The memory circuitry is operable to store data files therein. The extended memory controller circuitry is operable to control data file storage and retrieval to and from the memory circuitry.

The extended memory controller circuitry is further operable to control interface of the extended memory card through either the first format connection fingers or the second format connection fingers with a host device to transfer data files from the host device to be stored on the memory circuitry, and to retrieve data files from the memory circuitry to the host device.

### CROSS REFERENCE TO RELATED APPLICATIONS

This application is a continuation in part of U.S. Patent application for “Backward compatible extended-MLC USB plug and receptacle with dual personality”, U.S. application Ser. No. 11/864,696, filed Sep. 28, 2007, the entire disclosure of which is incorporated herein by reference.

This application is a continuation in part of U.S. Patent application for “Extended Secure-Digital (SD) Card Devices and Hosts”, U.S. application Ser. No. 10/854,004 filed May 25, 2004, the entire disclosure of which is incorporated herein by reference, and which is a CIP of application Ser. No. 10/708,172, now U.S. Pat. No. 7,021,971.

This application is a continuation in part of U.S. Patent application for “Electronic data storage medium with fingerprint verification capability”, U.S. application Ser. No. 11/624,667, filed Jan. 18, 2007, the entire disclosure of which is incorporated herein by reference, and which is a division of application U.S. application Ser. No. 09/478,720, filed Jan. 6, 2000.

This application is a continuation in part of U.S. Patent application for “New package and manufacturing method for multi-level cell multi-media card”, U.S. application Ser. No. 11/929,957, filed Oct. 30, 2007, the entire disclosure of which is incorporated herein by reference.

### BACKGROUND OF THE INVENTION

1. Field of the Invention

The present invention relates generally to the field of portable flash memory cards, and particularly to portable flash memory cards with multiple interfaces.

2. Description of the Prior Art

One data storage media in popular use today is flash memory, which gets its name because the microchip therein is so organized that a section of memory cells are erased in a single action or “flash.” Flash memory is used in cellular phones, digital cameras, LAN switches, memory cards for notebook computers, digital set-top boxes, embedded controllers, and other devices. Portable and removable flash memory cards allow users to transfer digital data files between devices. Due to their smaller size and larger storage capacities, flash memory cards have, to a large extent, replaced floppy disks.

As flash memory technology becomes more advanced, it is replacing traditional magnetic disks as storage media for mobile systems. Flash memory has numerous advantages over magnetic hard disks, such as high-G resistance and low power dissipation. Because of their smaller physical size, flash memory devices are also more conducive to mobile systems. Accordingly, the use of flash memory has grown with the proliferation of mobile, low power consumption devices.

Advances in flash technologies, however, have created a greater variety of flash memory device types with varying performance, cost, physical dimensions, storage capacity, and connection method characteristics. Currently, the more popular flash memory device types include those that are based on USB (Universal Serial Bus), Secure Digital (SD) card, Multi-Media Card (MMC), SmartMedia card, PCIE Card (ExpressCard), and CompactFlash card (CF card) formats.

Although, SD and MMC are similar, most of the other flash memory devices have different interfaces and form factors, resulting in incompatibility issues. As a result, users often resort to different means to transfer data between flash memory devices of varying types.

There is, thus, a great need for memory cards that minimize the inconvenience associated with dealing with the numerous interfaces used by the various memory flash devices.

### SUMMARY OF THE INVENTION

Briefly, an embodiment of the present invention includes an extended memory card comprising memory circuitry, extended memory controller circuitry, a plurality of first format connection fingers, and a plurality of second format connection fingers. The memory circuitry is operable to store data files therein. The extended memory controller circuitry is operable to control data file storage and retrieval to and from the memory circuitry. The extended memory controller circuitry is further operable to control interface of the extended memory card through either the first format connection fingers or the second format connection fingers with a host device to transfer data files from the host device to be stored on the memory circuitry, and to retrieve data files from the memory circuitry to the host device.

The foregoing and other objects, features and advantages of the present invention will be apparent from the following detailed description of the embodiments of the present invention which make reference to several figures of the drawing.

### IN THE DRAWINGS

FIG. 1 shows a block diagram of an extended memory card 100 capable of interacting with a universal serial bus (USB) USB host 10 or a secure digital (SD) or multi-media card (MMC) host 20 according to an embodiment of the present invention.

FIG. 2 shows a block diagram of an extended memory card 200 capable of interacting with a USB host 10 or an SD/MMC host 20 according to a different embodiment of the present invention.

FIG. 3 shows a block diagram of an extended memory card 300 capable of interacting with a USB host 10 or an SD/MMC host 20 according to a different embodiment of the present invention.

FIG. 4 shows a block diagram of the extended memory card 300 coupled to a USB host device 10.

FIG. 5 shows a block diagram of the extended memory card 300 coupled to an SD/MMC host 20.

FIG. 6 shows an angular top view 401 and an angular bottom view 402 of a chip on board (COB) 400 which is a component of an extended memory card extended memory card 350 (shown in FIG. 7) according to an embodiment of the present invention.

FIG. 7 shows a bottom angular view 416 of a housing 320, an exploded view 418 of an extended memory card 350, and a bottom angular view of a 422 according to an embodiment of the present invention.

FIG. 8 shows a top angular view 340 and a bottom angular view 341 of the extended memory card 350 without the protector cap 330.

FIG. 9 shows an exploded view 601 of a PCBA/connector assembly 630, an exploded view 602 of an extended memory card 600, and a top angular view 603 of an extended memory card 600 according to an embodiment of the present invention.

FIG. 10 shows an exploded view 604 and a bottom angular view 605 of the PCBA 612 with additional details according to an embodiment of the present invention.

FIG. 11 shows a bottom angular view 701 and a top angular view 702 of a Chip on Board (COB) 750, which is a component of an extended memory card 700 (shown in FIG. 12) according to an embodiment of the present invention.

FIG. 12 shows an exploded view 703, angular top view 704, and angular bottom view 705 of the extended memory card 700, as well as a bottom view 706 of the COB 750, according to an embodiment of the present invention.

FIG. 13 shows a bottom angular view of a top cover 730, which, in one embodiment of the present invention, is a component of extended memory card 700, with further details, according to an embodiment of the present invention.

FIG. 14 shows an exploded view of a 901, of an extended memory card 900, and a bottom side angular view 902 of a printed circuit board assembly (PCBA) 930, which is a component of the extended memory card 900, according to an embodiment of the present

FIG. 15 shows an angular bottom view of the top cover 910 with additional details according to an embodiment of the present invention.

FIG. 16 shows a top angular view 903 and a bottom angular view 904 of the extended memory card 900 according to an embodiment of the present invention.

### DETAILED DESCRIPTION OF THE PREFERRED EMBODIMENT OF THE PRESENT INVENTIONS

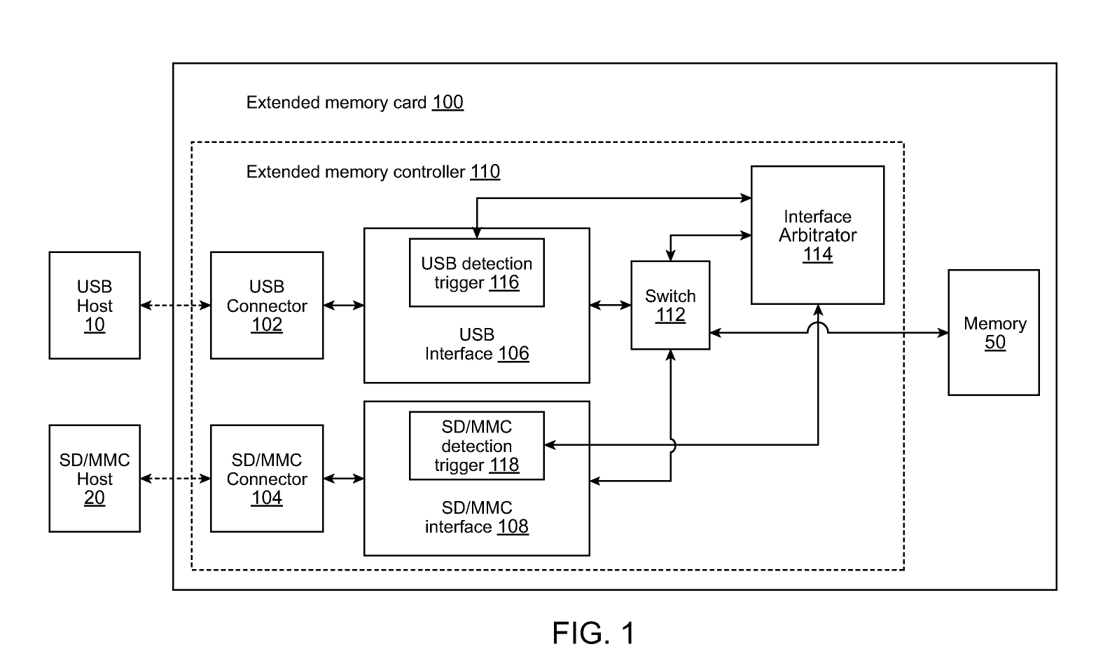

Referring now to FIG. 1, a block diagram of an extended memory card 100 is shown capable of interacting with a universal serial bus (USB) USB host 10 or a secure digital (SD) or multi-media card (MMC) host 20 according to an embodiment of the present invention. The USB host 10 and SD/MMC host 20 can be any device that can benefit from external, removable, portable memory. By way of example only, the USB host 10 and SD/MMC host 20 can be a digital camera, mobile telephone, personal computer (PC), personal digital assistant (PDA) or other device.

The USB host 10 communicates with external memory devices through a USB connection device and associated protocol, commonly used and adopted in the industry. The SD/MMC host 20 communicates with external memory devices through the SD or MMC connection device and associated protocol. It should be noted that the SD and MMC connection devices and protocols are substantially interchangeable and cross-compatible, and as used herein, “SD/MMC” refers to connectors and protocols of either standard.

Furthermore, it should be noted that USB and SD/MMC host are only exemplary, and that in other embodiments of the present invention, the memory card 100 can interface with hosts in any of the formats commonly used in the removable storage industry. Examples of some formats commonly used include SmartMedia card, Memory Stick (MS), PCIE Card (ExpressCard) and CompactFlash cards (CF card).

The memory card 100 is shown to include an extended memory controller 110 and a memory 50. The memory controller 110 and the memory 50 are shown to be coupled. The memory controller 110 is shown to include a USB connector 102, an SD/MMC connector 104, a USB interface controller 106, an SD/MMC interface controller 108, a switch 112, and an interface arbitrator 114. The USB connector 102 is shown to be coupled to the USB interface controller 106. The SD/MMC connector 104 is shown to be coupled to the SD/MMC interface controller 108. The USB interface controller 106 is shown to include a USB detection trigger 116. The SD/MMC interface controller 108 is shown to include an SD/MMC detection trigger 118. The USB detection trigger 116 and the SD/MMC detection trigger 118 are shown to be both coupled to the interface arbitrator 114. The USB interface controller 106 and the SD/MMC interface controller 108 are also shown to be coupled to the switch 112. The switch 112 is shown to be coupled to the interface arbitrator 114. The switch 112 is further shown to be coupled to the memory 50. As discussed in this paragraph, the components are coupled, for example, by way of one or a plurality of parallel conductive traces or wires disposed either in an integrated circuit (IC) or on the body of the memory card 100. Other connection methods known and used in the industry are also contemplated.

The USB connector 102 connects with the USB host 10 in a manner conforming to the USB standard. The SD/MMC connector 104 connects with the SD/MMC host 20 in a manner conforming to the SD/MMC format. The physical structure and functionality of connectors are well-known to those in the industry, and a discussion thereof is unnecessary.

The interface controllers 106 and 108 may include a transceiver block, a serial interface engine block, data buffers, registers, error correction, and interrupt logic (not shown) to control interfacing between the host devices 10 and 20, connectors 102 and 104, and the memory 50. Each interface controller is designed to comply with its corresponding specification. For example, the USB interface controller 106 conforms to the USB format specifications, and the SD/MMC format conforms to the SD/MMC specifications, as published and used by the industry. However, some building blocks in the two interface controllers 106 and 108 perform similar or analogous functions, such as error correction circuitry or control of reading/writing data in flash memory. The implementation of the two discrete interface controllers 102 and 104 may demand a larger silicon area because the similar building blocks are not being taken advantage of.

The USB detection trigger 116 and the SD/MMC detection trigger 118 are operable to send a detection signal to and receive commands from the interface arbitrator 114, as well as to relay the commands to the SD/MMC interface controller 106 and USB controller 108 respectively. The extended memory card 100 communicates with the USB host 10 or SD/MMC host 20 when the USB connector 102 or the SD/MMC connector 104 is coupled to the associated format host 10 or 20 by the user. Upon detecting the connection, the associated detection trigger 116 or 118 respectively sends out a detection signal to the interface arbitrator 114. The interface arbitrator 114 is responsive to detection signals from the two detection triggers 116 and 118, to process the received signals, and to send signals that direct the switch 112 in response thereto. When the interface arbitrator 114 receives a detection signal from one of the detection triggers 116 or 118, the interface arbitrator 114 sends a signal to the switch 112, causing the switch 112 to couple the appropriate interface controller 106 or 108 to the memory 50.

The interface arbitrator 114 is operative to decide to couple either the USB interface controller 106 or the SD/MMC interface controller 108 to the memory 50. Thereafter, the switch 112 selects between the USB interface controller 106 and the SD/MMC interface controller 108, as dictated by the interface arbitrator 114, and causes the selected interface controller to be coupled to the memory 50.

The memory 50 contains therein flash, multi-level cell (MLC) or other memory devices, or a combination thereof. It is contemplated that the memory 50 may include a hierarchy of memory devices, with smaller, faster memory devices acting as cache, and larger, slower memory devices acting as main memory. When the switch 112 connects the USB interface controller 106 to the memory 50, data can be transferred between the USB host 10 and the memory. Likewise, when the switch 112 connects the SD/MMC interface controller 108 to the memory 50, data can be transferred between the memory 50 and the SD/MMC host 20.

As a general example, many PCs are equipped with one or more USB connectors while portable digital cameras are often equipped with an SD or MMC connector. To transfer digital photos captured by a digital camera and stored in an SD/MMC card to a PC, the SD/MMC card cannot be directly plugged into the PC unless the PC is also equipped with an SD/MMC connector. The memory card 100, however, using the memory controller 110, advantageously stores and retrieves data through both USB and SD/MMC connectors. The foregoing connector types are examples of connectors, it is understood that other connector types are anticipated.

It should be noted that the use of two format connectors 102 and 104 is only exemplary. In different embodiments of the present invention, more than two connectors may also be used, in which case the number of format interfaces will be increased commensurately, and additional logic will be introduced into the interface arbitrator 214 and the switch 212.

As discussed above, the implementation of the two discrete interface controllers 102 and 104 may create a redundancy because the two interface controllers 102 and 104 may include identical logic and circuitry. In a different embodiment of the present invention, the overlapping control logic and circuitry is consolidated into a separate and distinct circuit independent of the type of the interface.

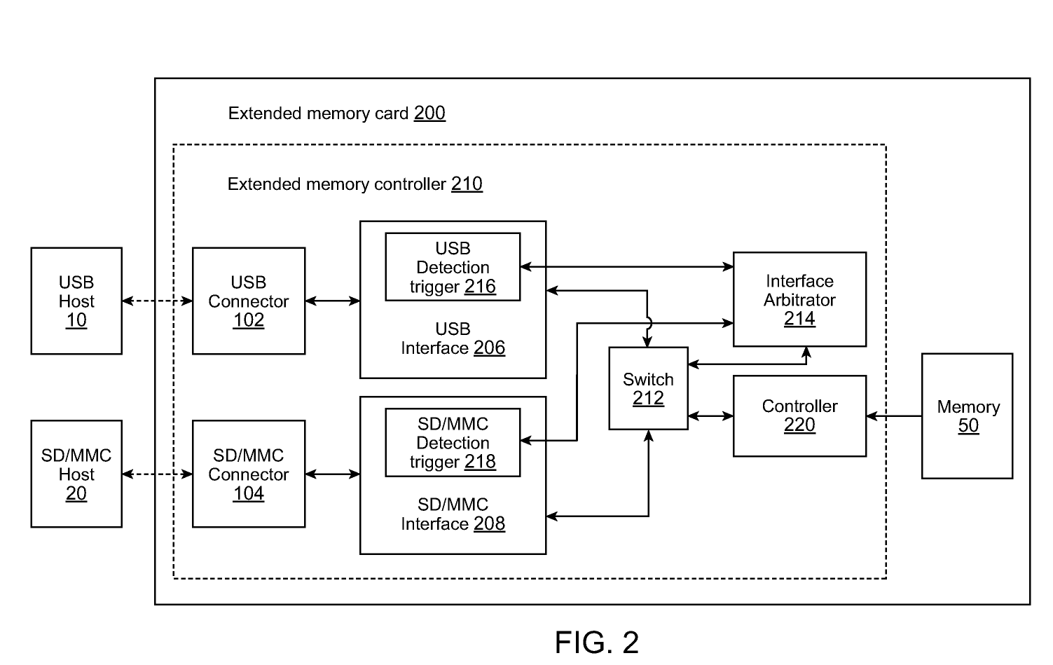

Referring now to FIG. 2, a block diagram of an extended memory card 200 is shown capable of interacting with a USB host 10 or an SD/MMC host 20 according to a different embodiment of the present invention. As with the embodiment shown in FIG. 1, the USB and SD/MMC hosts are only exemplary, and in other embodiments of the present invention, the memory card 200 can interface with hosts in any format commonly used in the industry.

The memory card 200 is shown to include an extended memory controller 210 and a memory 50. The memory controller 210 and the memory 50 are shown to be coupled. The memory controller 210 is shown to include a USB connector 102, an SD/MMC connector 104, a USB interface 206, an SD/MMC interface 208, a switch 212, an interface arbitrator 214, and a controller 220. The USB interface 206 is shown to include a USB detection trigger 216. The SD/MMC interface 208 is shown to include an SD/MMC detection trigger 216. The USB connector 102 is shown to be coupled to the USB interface 206. The SD/MMC connector 104 is shown coupled to the SD/MMC interface 208. The USB detection trigger 216 and the SD/MMC detection trigger 218 are both shown to be coupled to the interface arbitrator 214. The USB interface 206 and the SD/MMC interface 208 are also shown to be coupled to the switch 212. The switch 212 is shown to be coupled to the interface arbitrator 214. The controller 220 is further shown to be coupled to the memory 50. As discussed in this paragraph, the components are coupled, for example, by way of one or a plurality of parallel conductive traces or wires disposed, either in an integrated circuit (IC) or on the body of the memory card 200. Other connection methods known and used in the industry are also contemplated.

The USB host 10 and SD/MMC host 20, as well as the USB connector 102 and SD/MMC connector 104 shown in FIG. 2 are analogous to their counterparts shown in FIG. 1 above. Further discussion thereof is avoided in order to eliminate redundancy. The USB interface 206 and the SD/MMC interface 208 contain some of the logic and circuitry contained in the USB interface controller 106 and SD/MMC interface controller 108, respectively. More precisely, the USB interface 206 and SD/MMC interface 208 are operative to process compatibility issues and data flow. The remainder of the functions of the USB interface 206 and SD/MMC interface 208 is performed by the controller 220. More precisely, the controller 220 performs read or write functions including various controls and error corrections. Placing the redundant circuitry in a single controller 220 advantageously reduces silicon size (thereby reducing costs), resulting in either a smaller memory card 200, or additional space for more memory 50.

The extended memory card 200 communicates with the USB host 10 or the SD/MMC host 20 when either the USB connector 102 or the SD/MMC connector 104 is coupled to a USB host 10 or SD/MMC host 20, respectively, by the user. Upon detecting the connection, the USB detection trigger 216 or SD/MMC detection trigger 218 sends out a detection signal to the interface arbitrator 214. The interface arbitrator 214 is operative to receive detection signals from the detection triggers 216 and 218, to process these signals, and to send signals that direct the switch 212 in response thereto. When the interface arbitrator 214 receives a detection signal from one of the detection triggers 216 or 218, the interface arbitrator 214 sends a signal to the switch 212, causing the switch 212 to couple either the USB interface 206 or SD/MMC interface 208, as appropriate, to the controller 220. The controller 220 is operative to perform read or write functions, including various controls and error corrections. The controller 220 communicates with the memory 50. The memory 50 shown in FIG. 2 is analogous to the memory 50 shown in FIG. 1, and a detailed discussion thereof is avoided in order to eliminate redundancy. When the switch 212 connects either the USB interface 206 or the SD/MMC interface 208 to the controller 220, data can be transferred between the memory 50 and either the USB host 10 or SD/MMC host 20, respectively.

The interface arbitrator 214 is operative to decide to couple either the USB interface 206 or the SD/MMC interface 208 to the memory 50. Thereafter, the switch 212 selects between the USB interface 206 and the SD/MMC interface 208, as dictated by the interface arbitrator 214, and causes the selected interface to be coupled to the memory 50.

The controller 220 in FIG. 2 consolidates certain overlapping blocks so that data from the USB interface 206 and the SD/MMC interface 208 go through the same circuitry. Thus, the controller 220 advantageously results in a smaller silicon area than the total area occupied by the USB interface controller 106 and the SD/MMC interface controller 108 in FIG. 1. The use of the controller 220, however, results in the need for additional circuitry because the USB and SD/MMC formats are compliant with different specifications. Therefore, in the embodiment of the present invention shown in FIG. 2, the controller 220 has to be designed in such a way that it can receive or send data to and from the USB interface 206 and SD/MMC interface 208 in accordance with the two different specifications.

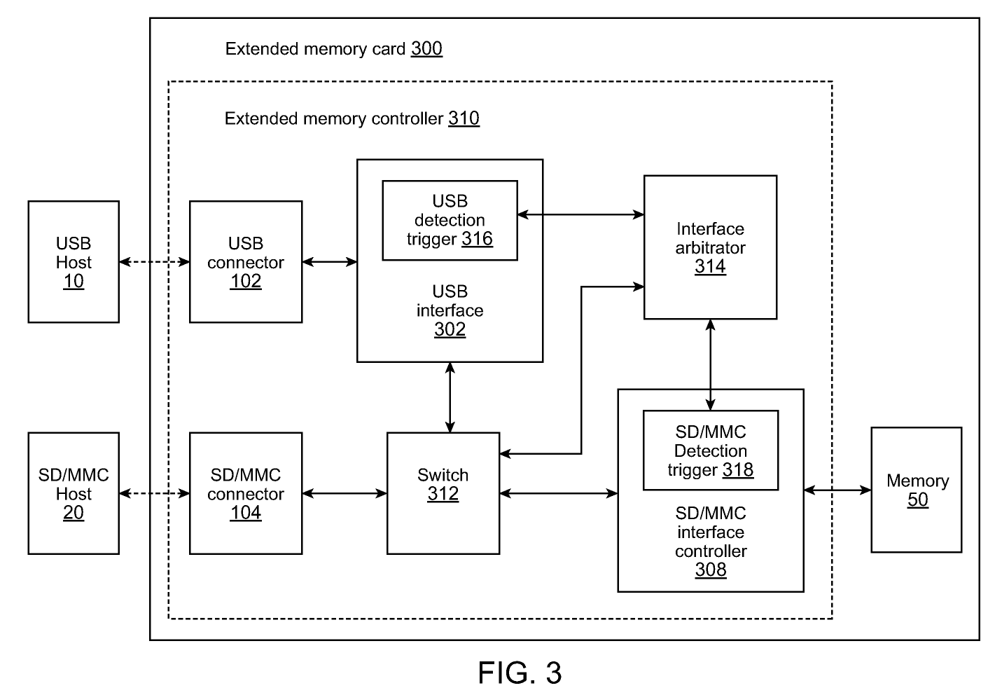

Referring now to FIG. 3 a block diagram of an extended memory card 300 is shown capable of interacting with a USB host 10 or an SD/MMC host 20 according to a different embodiment of the present invention.

The memory card 300 is shown to include an extended memory controller 310 and a memory 50. The memory controller 310 and the memory 50 are shown to be coupled. The memory controller 310 is shown to include a USB connector 102, an SD/MMC connector 104, a USB interface 302, an interface arbitrator 314, a switch 312, and an SD/MMC interface controller 308. The USB interface 302 is shown to contain a USB detection trigger 316. The SD/MMC interface controller 308 is shown to include an SD/MMC detection trigger 318. The USB connector 102 is shown to be coupled to the USB interface 302. The SD/MMC connector 104 is shown to be coupled to the switch 312, which is shown to be also coupled to the USB interface 302, the interface arbitrator 314, and the SD/MMC interface controller 308. The interface arbitrator 314 is shown to be coupled to the USB detection trigger 316 and the SD/MMC detection trigger 318. The SD/MMC interface controller 308 is shown to be coupled to the memory 50. As discussed in this paragraph, the components are coupled, for example, by way of one or a plurality of parallel conductive traces or wires disposed, either in an integrated circuit (IC) or on the body of the memory card 300. Other connection methods known and used in the industry are also contemplated. Furthermore, the USB host 10 and SD/MMC host 20 and associated components shown are only exemplary, and in other embodiments, use of any of the other formats commonly used in the industry for removably connecting portable memory cards to host devices is anticipated.

The function and structure of the USB connector 102 and the SD/MMC connector 104 shown in FIG. 3 is similar to the function of the USB connector 102 and the SD/MMC connector 104 shown in FIGS. 1 and 2, and a detailed discussion thereof is avoided here to eliminate redundancy.

The SD/MMC interface controller 308 is operable to control and interface between the SD/MMC host 20, the SD/MMC connector 104, and the memory 50.

Similar to the memory controller 110 in FIG. 1 and the memory controller 210 in FIG. 2, the memory controller 310 is operable to communicate with two different types of host devices. However, memory controller 300 has features that memory controllers 110 and 210 lack. One of the advantages of the memory controller 300 of FIG. 3 is to minimize the additional functional blocks to handle the differences in the corresponding interface specifications.

As shown in FIG. 3, a complete SD/MMC interface controller 308 is coupled to the memory 50. Furthermore, a USB interface 302 is coupled to the SD/MMC interface controller 308 via a switch 312.

In operation, when the flash memory card 300 communicates with a USB host 10, the USB detection trigger 316 sends out a detection signal to the interface arbitrator 314. The interface arbitrator 314 sends a signal to the switch 312, causing the switch 312 to couple the USB interface 302 to the SD/MMC interface controller 308. The SD/MMC interface controller 308 is operable to cause data to be written to or read from the memory 50 to and from the USB host 10 via the USB connector 102 and the USB interface 302.

The interface arbitrator 314 is operative to decide to couple either the USB interface 302 or the SD/MMC interface controller 308 to the memory 50. Thereafter, the switch 312 selects between the USB interface 302 and the SD/MMC interface controller 308, as dictated by the interface arbitrator 314, and causes the selected block to be coupled to the memory 50.

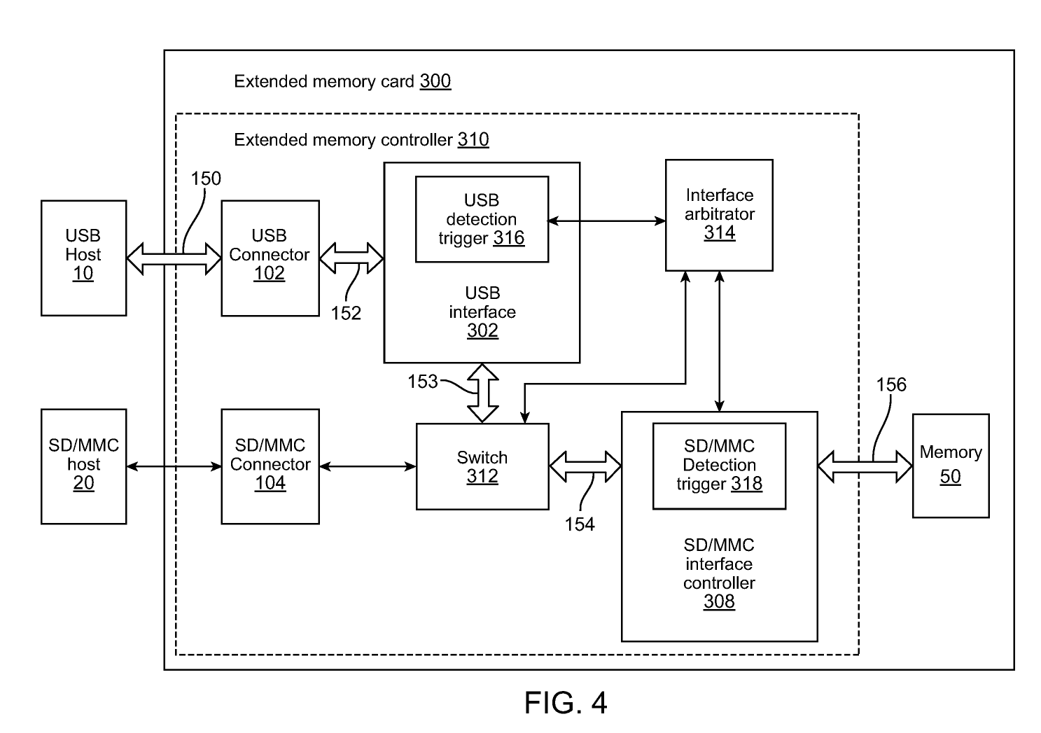

Referring now to FIG. 4, a block diagram of the extended memory card 300 is shown coupled to a USB host device 10. FIG. 4 shows the dataflow path between the USB host 20 and the memory 50 of the extended memory card 300. The components and the connections shown in FIG. 4 are identical to those shown in FIG. 3. FIG. 4 shows data transfer between USB host 10 and the extended memory card 300. The USB host 10 is coupled through the connection 150 to the USB connector 102 on the memory card 300. The USB connector 102 is coupled to the USB interface 302 through the connection 152. The USB interface 302 is coupled through the connection 153 to the switch 312. The switch 312 is coupled through the connection 154 to the SD/MMC interface controller 308. The SD/MMC interface controller 308 is coupled, through the connection 156, to the memory. The interface controller 308 controls the data transfer from the USB interface 302 to the memory 50.

Conversely, the extended memory card 300 is capable of interfacing with an SD/MMC host 20. In order to interface with an SD/MMC host 20, the extended memory card 300 is coupled to the SD/MMC host 20 via the SD/MMC connector 104. When the connection is made, the SD/MMC detection trigger 318 sends out a detection signal to the interface arbitrator 314. The interface arbitrator 314 sends a signal to control the switch 312 so that the SD/MMC interface (not shown) of the SD/MMC host 20 can communicate with the SD/MMC interface controller 308 through the SD/MMC connector 104. When the switch 312 connects the SD/MMC connector 104 to the SD/MMC interface controller 304, data can be written to or read from the memory 50 to and from the SD/MMC host 20.

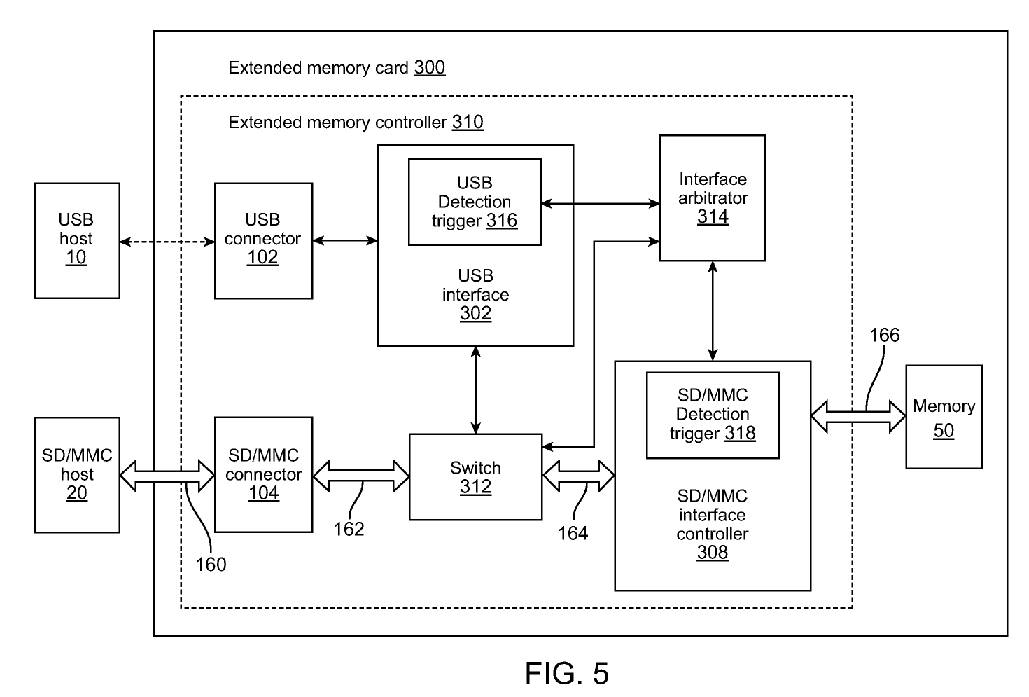

Referring now to FIG. 5, a block diagram of the extended memory card 300 is shown coupled to an SD/MMC host 20. The components and the connections shown in FIG. 5 are identical to those shown in FIG. 3. FIG. 5 shows the dataflow path between the SD/MMC host 20 and the memory 50 of the extended memory card 300. The SD/MMC host 20 is coupled, through the connection 160, to the SD/MMC connector 104 on the memory card 300. The SD/MMC connector 104 is coupled, through the connection 162, to the switch 312. The switch 312 is coupled, through the connection 164, to the SD/MMC interface controller 308. The SD/MMC interface controller is coupled, through the connection 166, to the memory 50. The SD/MMC interface controller 308 controls and interfaces the data transfer from the SD/MMC connector 104 to the memory 50.

In one embodiment of the present invention, the dataflow shown in FIG. 5 is the default dataflow. In other words, the switch 312 by default couples the SD/MMC interface controller 308 to the SD/MMC connector 104. Unless the USB connector 102 of the memory card 300 is plugged into a USB interface of a USB host 10, the interface arbitrator 314 causes the switch 312 to connect the SD/MMC interface controller 308 to the SD/MMC connector 104. When the memory card 300 is in communication with a USB host 10, the interface arbitrator 314 sends a control signal to cause the switch 312 to connect the SD/MMC interface controller 308 to connect to the USB interface 302.

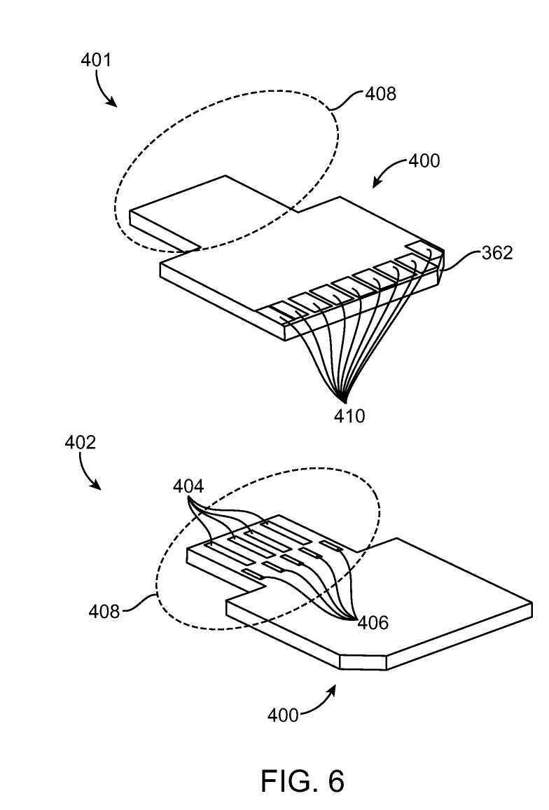

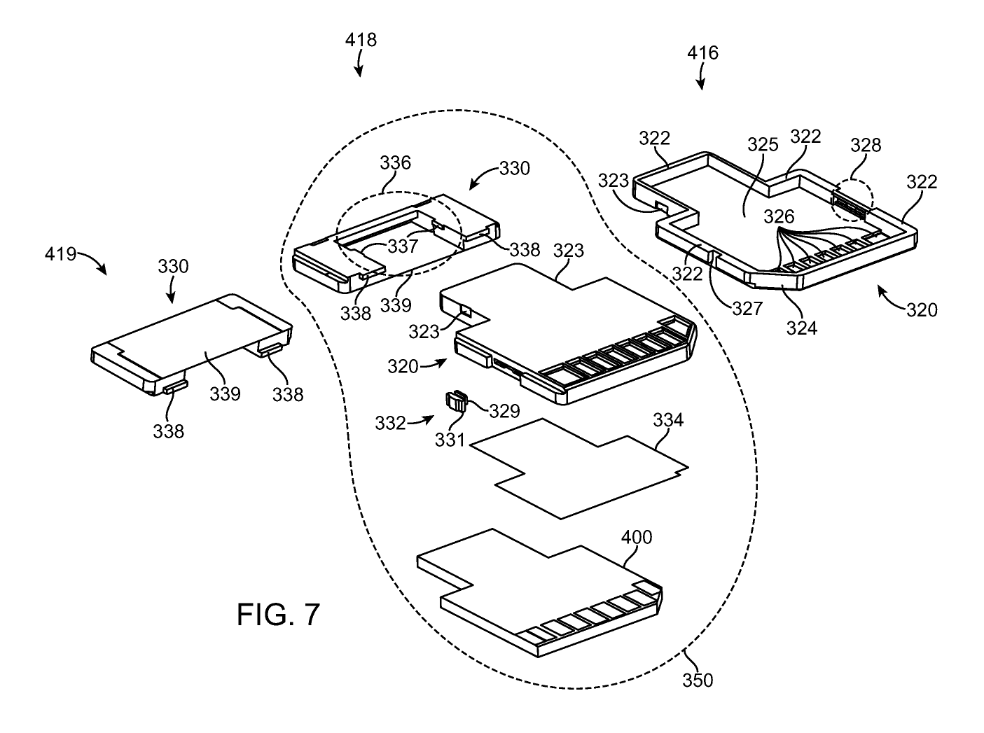

Referring now to FIG. 6, an angular top view 401 and an angular bottom view 402 of a chip on board (COB) 400, which is a component of an extended memory card extended memory card 350 (shown in FIG. 7) is shown according to a different embodiment of the present invention. It is noted that the dashed lines are not any part of the structures shown in FIG. 6.

The angular top view 401 shows the chip on board 400 to be generally T-shaped, and to include a corner notch 362, shaped generally as a triangular cutout, situated on one corner thereof. The COB 400 is shown to further include a USB connection pad 408, shaped generally as a square, and a plurality of SD/MMC connection fingers 410 situated on the edge opposite to the USB connection pad 408. The SD/MMC connection fingers 410 are shown to be generally rectangular shaped. In an embodiment of the present invention, the SD/MMC connection fingers 410 are formed from conducting materials such as copper. However, it is anticipated that in other embodiments of the present invention, the SD/MMC connection fingers 410 could be formed from other metals.

In an embodiment of the present invention, the shape, position, and number of the SD/MMC connection fingers 410 conform to the shape, position, and number of connector pins in the MMC or SD standards. It is anticipated, however, that in other embodiments of the present invention, the shape, position, and number of the SD/MMC connection fingers 410 may conform to other memory card standards.

The COB 400 is operable to allow the COB 400 to store therein data files, and to communicate with host devices in at least three different formats. The COB 400 is further operable to allow the COB to store data files from the host device and to retrieve data files and transfer the data files to the host device, as discussed hereinabove.

The COB 400 is formed using COB technology. COB fabrication technology is well-known to those in the industry, but, by way of example, generally includes the manufacturing of a chip or integrated circuit (IC), surface mounting the IC and connectors on a printed circuit board (PCB), and thereafter, placing the PCB in a mold and pouring plastic, resin, or epoxy on the PCB, yielding a single, encapsulated device containing a chip.

The angular bottom view 402 shows the COB 400 to include a plurality of USB connection fingers 404 and a plurality of extended USB connection fingers 406 situated on the USB connection pad 408. In one embodiment of the present invention, the USB connection fingers 404 and extended USB connection fingers 406 are formed from conducting materials such as copper, but use of other conducting materials is also anticipated. In an embodiment of the present invention, the size, shape, and number of the USB connection fingers 404 conform to connecting pins in a USB connector. However, it is anticipated that in other embodiments, the size, shape, and number of USB connection fingers 404 may conform to other connectors.

In one embodiment of the present invention, the extended USB connection fingers 406, together with the USB connection fingers 404, connect the extended memory card extended memory card 350 (shown in FIG. 6) to a host device (not shown) enabling the extended memory card extended memory card 350 to transfer data files to and from the host device at speeds higher than the USB standard (extended USB). In one embodiment of the present invention, the interface, controller, and trigger circuitry discussed hereinabove allow the extended memory card extended memory card 350 to communicate with both a USB and an extended USB host device.

Referring now to FIG. 7, a bottom angular view 416 of a housing 320, an exploded view 418 of a extended memory card 350, and a bottom angular view of a protector cap 330 are shown according to an embodiment of the present invention. It is noted that the dashed lines are not any part of the structures shown in FIG. 7.

The bottom angular view 416 of the housing 320 shows the housing 320 to be generally T-shaped, with a corner notch 324, shaped generally as a triangular cutout situated on one corner, and raised edges 322 along all sides, creating a center cavity 325. The housing 320 is further shown to include a positioning notch 327, which is shaped generally as a square cutout, on one side thereof. The housing 320 is further shown to include a plurality of SD/MMC connector openings 326, shaped generally as rectangular cutouts along one edge thereof. The housing 320 is shown to further include a slider switch window 328, shaped generally as a rectangular opening in the raised edges 322 on one edge thereof, and an SD/MMC connector openings 326, shaped generally as a rectangular cutout on the opposite edge thereof. The shape, size, and number of the SD/MMC connector openings 326 conform to the shape, size, and number of SD/MMC connection fingers 410 on the COB 400 (shown in FIG. 6), as will be discussed further hereinbelow. The housing 320 is further shown to include a cap lock groove 323, shaped generally as a rectangular notch, on one side thereof. The housing 320 includes a second cap lock groove 323, not visible in the bottom angular view 416, but visible in the exploded view 418, and discussed hereinbelow. It should be noted that where numbers are provided, they are exemplary, and other numbers are anticipated in other embodiments of the present invention.

The exploded view 418 shows the extended memory card 350 to include a protector cap 330, a housing 320, a slider switch 332, a thermal bond adhesive film 334, and a COB 400. The exploded view 418 shows an angular view of the protector cap 330 to be generally rectangular in shape, with a USB connector notch 336, shaped generally as a rectangular cutout generally in the middle thereof and shaped substantially similar to the USB connection pad 408 (shown in FIG. 6). The protector cap 330 is further shown to include a connector protection surface 339, shaped generally as a flat surface along one side of the USB connector notch 336. The USB connector notch 336 is shown to include two inside snap notches 337, shaped generally as protrusions from the inner edge of the USB connector notch 336, facing inward relative to the USB connector notch 336. The protector cap 330 is further shown to include two outside snap notches 338, shaped generally as rectangular protrusions, facing outward relative to the edge, on one side thereof. It should be noted that in other embodiments of the present invention, a thermal bond adhesive film 334 is not used, as will be discussed further hereinbelow.

The housing 320 is shown to include two cap lock groove 323, shaped generally as rectangular notches on the sides thereof.

The slider switch 332 is shown to be generally I-shaped, with an outer face 313 and an inner face 329 joined together.

The thermal bond adhesive film 334 is shown to be generally T-shaped, such that it fits into the center cavity 325 of the housing 320, without obstructing the SD/MMC connector openings 326.

In assembly, the slider switch 332 is snapped into the slider switch window 328 of the housing 320. Thereafter, the 334 is placed into the 325 of the 320 housing, and the COB 400 is placed on top thereof, such that the SD/MMC connection fingers 410 of the COB 400 are visible through the SD/MMC connector openings 326 of the housing 320. Thereafter, the housing 320, thermal bond adhesive film 334, and COB 400 are thermally bonded together. In various embodiments of the present invention, the thermal bonding may include use of double-sided adhesive film such as 3M adhesive transfer tape 200 MP, or 3M thermal-bond film TBF668, applied to the inside housing surface, whereupon the top cover 320 and COB 400, joined together with a press fixture, are passed through an oven maintained at a specified temperature to activate or cure the adhesive. In other embodiments of the present invention, high viscosity adhesive may be applied by manual or automatic dispensing machines. A press fixture may be used to hold the top cover 320 and COB 400 in position until the adhesive cures.

The protector cap 330 a bottom angular view of which is shown in view 419, is removably attached to the housing 320, such that the 338 of the protector cap 330 snap into the cap lock groove 323 of the housing 320, thus holding the protector cap 330 in place. When the protector cap 330 is removably attached to the housing 320, the connector protection surface 339 of the protector cap 330 covers and protects the USB connection fingers 404 and 306. In one embodiment of the present invention, when the protector cap 330 is removably attached to the housing 320, the shape of the extended memory card 350 conforms to the shape of an MMC or SD memory card.

In operation, the extended memory card 350 can communicate with either a USB, extended USB, or SD/MMC host. SD/MMC hosts include a connector (not shown) that includes a protrusion (not shown) such that when the extended memory card 350 is correctly connected to the SD/MMC host, the corner notch 324 fits into the protrusion. If a user attempts to incorrectly connect the host to the extended memory card 350, the SD/MMC host's protrusion will prevent the extended memory card 350 from being fully inserted into the SD/MMC host's connector.

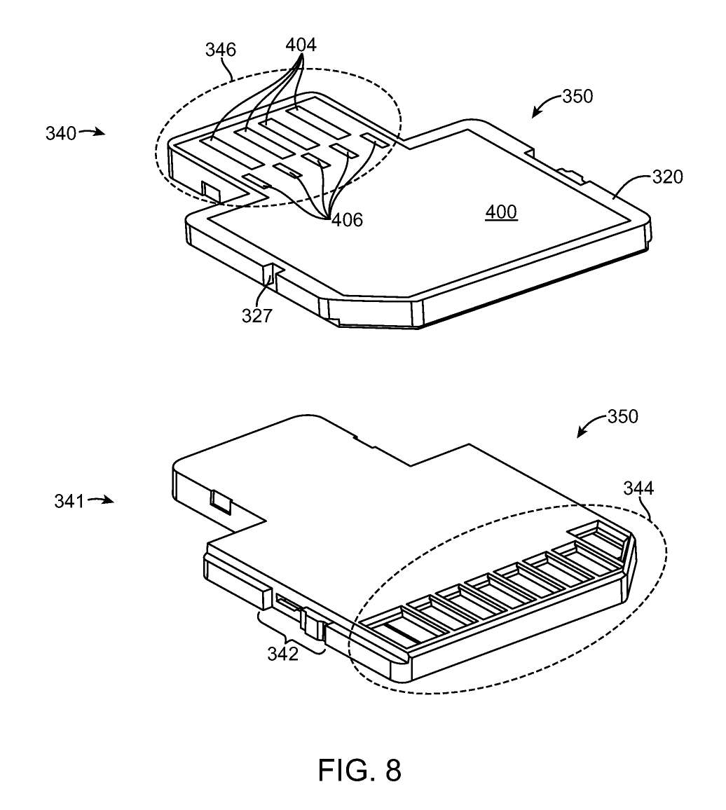

Referring now to FIG. 8, a top angular view 340 and a bottom angular view 341 of the extended memory card 350 is shown without the protector cap 330. It is noted that the dashed lines are not any part of the structures shown in FIG. 8.

The extended memory card 350 is shown to include an SD/MMC connector 344, which is substantially formed by the SD/MMC connection fingers 410 of the COB 400 (shown in FIG. 6) being exposed through the SD/MMC connector openings 326 of the housing 320 (shown in FIG. 7). In one embodiment of the present invention, the SD/MMC connector 344 allows the extended memory card 350 to connect and interface with host devices (not shown) compatible with the SD or MMC format.

The extended memory card 350 is further shown to include a USB based connector 346, which is generally square shaped, and is substantially formed by the USB connection fingers 404 and extended USB connection fingers 406 of the COB 400 (shown FIG. 6). In one embodiment of the present invention, the USB connection fingers 404 of the USB based connector 346 are operable to connect the extended memory card 350 to a host device (not shown) that utilizes a standard USB connector. Furthermore, in one embodiment of the present invention, the USB connection fingers 404 and extended USB connection fingers are jointly operable to connect the extended memory card 350 to a host device (not shown) that utilizes an extended USB standard.

In one embodiment of the present invention, the extended memory card 350 connects to a host device (not shown) that contains therein a cavity, and the extended memory card 350 is placed into the cavity as part of the connection process. When the extended memory card 350 is placed in a host device cavity, the host device may have a protrusion that fits into the positioning notch 327 of the extended memory card 350, firmly holding the extended memory card 350 in the host device cavity.

The extended memory card 350 is further shown to include a slider mechanism 342, which is generally a sliding switch formed by the slider switch 332 partly protruding from the slider switch window 328 of the housing 320. In one embodiment of the present invention, the slider mechanism 342 is operable to prevent users from accidentally or intentionally deleting, erasing data files from the extended memory card 350, or adding data files to the extended memory card 350. When users are prevented from modifying, deleting, or adding to the data files stored on the extended memory card 350, the extended memory card 350 is deemed “locked.” In one embodiment of the present invention, users lock the extended memory card 350 by moving the slider switch 332 towards the SD/MMC connector 344. In other embodiments of the present invention, moving the slider switch 332 towards the USB based connector 346 locks the extended memory card 350.

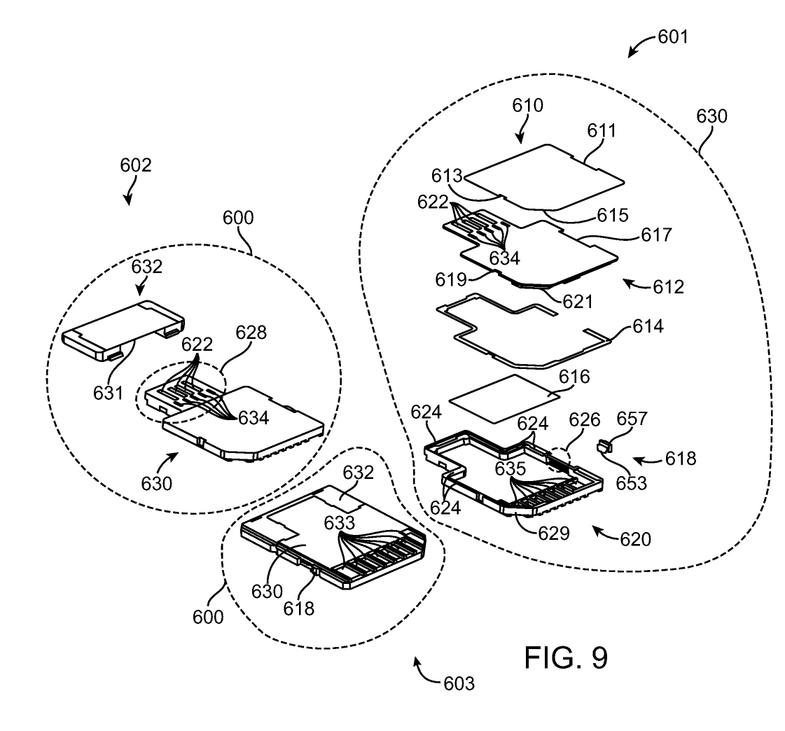

Referring now to FIG. 9, an exploded view 601 of a PCBA/connector assembly 630, an exploded view 602 of an extended memory card 600, and a top angular view 603 of a extended memory card 600 are shown according to a different embodiment of the present invention. It is noted that the dashed lines are not any part of the structures shown in FIG. 9.

The exploded view 601 shows the PCBA/connector assembly 630 to include a label 610, a printed circuit board assembly (PCBA) 612, a top adhesive film 614, a bottom adhesive film 616, a slider switch 618, and a card housing 620. It should be noted that in other embodiments of the present invention, the top adhesive film 614 and bottom adhesive film 616 are not used, and the PCBA 612 is joined with the card housing 620 using other methods, as discussed above.

The label 610 is shown to be substantially shaped as a flat square, with a slider notch 611, positioning notch 613, and corner notch 615 cut outs. The slider notch 611 is shown to be a generally rectangular shaped cutout situated on one edge of the label 610. The positioning notch 613 is shown to be a generally square shaped cutout situated on the edge opposite of the edge on which the slider notch 611 is situated. The corner notch 615 is shown to be a generally triangular cutout situated on one corner of the label 610.

The PCBA 612 is shown to be generally flat and T-shaped, and contain thereon a slider notch 617, positioning notch 619, and corner notch 621, as well as a plurality of USB connection fingers 622 and extended USB connection fingers 634. The slider notch 617 is shown to be a generally rectangular shaped cutout situated on one edge of the PCBA 612. The positioning notch 619 is shown to be a generally square shaped cutout situated on the edge opposite to the edge on which the 617 is situated. The corner notch 621 is shown to be a generally triangular cutout situated on one corner of the PCBA 612. The USB connection fingers 622 are shown to be generally rectangular in shape, and situated parallel to each other along one edge of the PCBA 612. The extended USB connection fingers 634 are shown to be generally rectangular in shape, and situated parallel to each other and in close proximity to the USB connection fingers 622.

In one exemplary embodiment, the number, shape, and position of the USB connection fingers 622 conform to the contact points in a USB standard connector, and the extended memory card 600 communicates with a host device (not shown) through the USB standard. In other embodiments, it is anticipated that the number, shape, and position of the USB connection fingers 622 conform to other standards, and that the extended memory card 600 communicates with a host device through other standards.

Furthermore, in one embodiment of the present invention, the extended USB connection fingers 634 and the USB connection fingers 622 jointly allow the extended memory card 600 to communicate with a host device (not shown) in the extended USB format.

The top adhesive film 614 is shown to be shaped generally as a narrow band substantially conforming in shape to the outer perimeter of the PCBA 612.

The bottom adhesive film 616 is shown to be generally flat rectangular in shape.

The slider switch 618 is shown to be generally shaped as a rectangular cube with an I-shaped cross section, a center channel 625 in the center, and an inner wall 653 and outer wall 657 on either side thereof.

The card housing 620 is shown to be generally T-shaped, with a corner notch 629, shaped generally as a triangular cutout, along one corner thereof, and raised edges 624 around the perimeter thereof. A slider switch opening 626 is shown situated in the middle of one edge of the card housing 620. The card housing 620 is further shown to include a plurality of SD/MMC connector openings 635, shaped generally as square or rectangular openings, along one edge thereof. In one embodiment of the present invention, the shape, size, and position of the SD/MMC connector openings 635 conform to the shape, size, and position of connectors on SD or MMC standards, and the extended memory card 600 communicates with a host device (not shown) through the SD or MMC standard. In other embodiments, it is anticipated that the SD/MMC connector openings 635 conform to other standards generally used by the industry, and the extended memory card 600 communicates with a host device through those standards.

The purpose of the corner notch 629 is discussed above, and further discussion is avoided herein to eliminate redundancy.

In assembly, the label 610 is attached to on top of the PCBA 612, for example by means of adhesives. The top adhesive film 614 is attached to the raised edges 624 of the card housing 620, and the bottom adhesive film 616 is attached to the general center of the card housing 620. Thereafter, the slider switch 618 is placed inside the slider switch opening 626, with the inner wall 653 of the slider switch 618 positioned inside the card housing 620, and the outside wall 657 of the slider switch 618 protruding outside thereof. Thereafter the PCBA 612 is attached to the card housing 620, forming the PCBA/connector assembly 630 shown in the exploded view 602 of the extended memory card 600, and discussed further hereinbelow. The adhesives that may be used for assembly, and methods for the use are discussed hereinabove, and are not discussed further in order to avoid redundancy.

The exploded view 602 of the extended memory card 600 shows the extended memory card 600 to be comprised of the PCBA/connector assembly 630 and a cap 632.

The PCBA/connector assembly 630 is shown to include a USB based connector 628, itself shown to include a plurality of USB connection fingers 622 and extended USB connection fingers 634. In the embodiment of the present invention shown in FIG. 9, the USB based connector 628 and the USB connection fingers 622 situated thereon are shaped to conform to USB standards, and the extended USB connection fingers 634 and the USB connection fingers 622 jointly conform to the extended USB standard. It should be noted that this is only exemplary, and it is contemplated that the USB based connector 628 may be shaped to conform with any of the connection standards used by the industry.

The cap 632 is shown to be generally rectangular in shape, with a connector opening 631 situated generally in the middle of one lengthwise edge thereof. The connector opening 631 is shown to be a generally rectangular shaped opening.

The exploded view 602 of the extended memory card 600 shows that the cap 632 is shaped to easily attach to the USB based connector 628 of the PCBA/connector assembly 630 when a user presses the two parts together. With the cap 632 attached to the PCBA/connector assembly 630, the USB connector 628 is covered by the cap 632, protecting the USB connection fingers 622 and 634 from the elements.

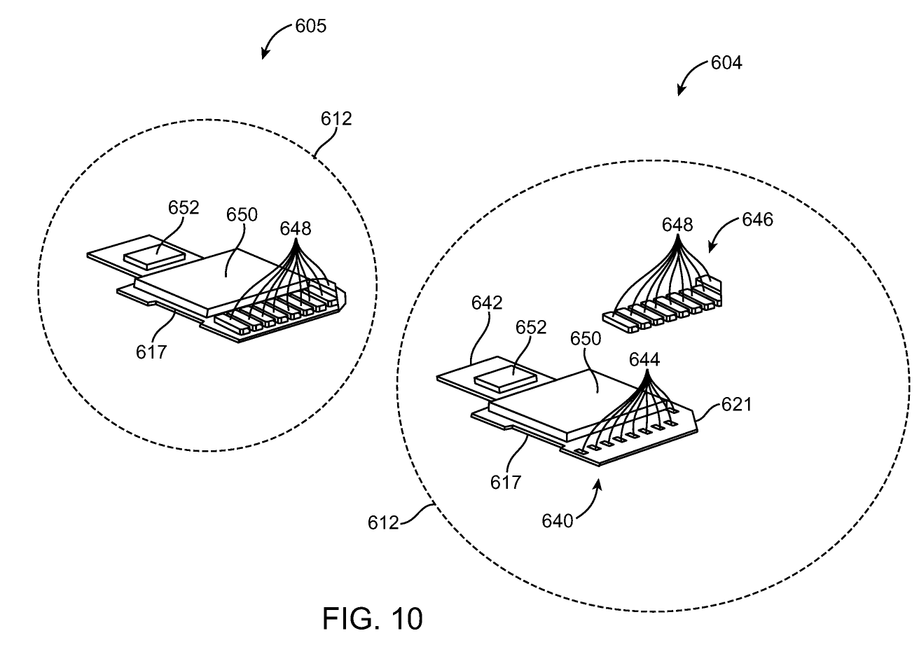

The top angular view 603 shows the extended memory card 600 when the cap 632 is attached to the PCBA/connector assembly 630. The top angular view 603 also shows the PCBA/connector assembly 630 to include a plurality of SD/MMC connection fingers 633. The SD/MMC connection fingers 633 substantially formed by the SD/MMC connector fingers 648 of the SD/MMC connector module 646, mounted on the PCBA 612 (shown in FIG. 10 and discussed further hereinbelow) exposed through the SD/MMC connector openings 635 of the card housing 620. In one embodiment, the shape, position, and number of SD/MMC connection fingers 633 conforms to the MMC or SD standards, and the extended memory card 600 communicates with a host device (not shown) through the MMC or SD standards. In other embodiments, it is anticipated that the shape, position, and number of the SD/MMC connection fingers 633 conform to other connection standards, and the extended memory card 600 communicates with host devices according to other standards.

In operation, the extended memory card 600 connects to a host device (not shown) through either the SD/MMC connection fingers 633 or the USB connector 628. Therefore, the extended memory card 600 is capable of communicating with the host device either through the SD/MMC standard or the USB standard. As discussed above, the circuitry in the extended memory card 600 detects the connection method, and directs the communication based thereon.

Referring now to FIG. 10, an exploded view 604 and a bottom angular view 605 of the PCBA 612 with additional details is shown according to an embodiment of the present invention. The exploded view 604 shows the PCBA 612 to include a PCB/IC assembly 640 and an SD/MMC connector module 646. The PCB/IC assembly 640 is shown to include a printed circuit board 642, a memory IC 650, a controller IC 652, and a plurality of connector pins 644. It is noted that the dashed lines are not any part of the structures shown in FIG. 10.

The printed circuit board 642 is shown to be generally flat and t-shaped, and to include a corner notch 621 and a slider notch 617. The corner notch 621 is shown to be shaped generally as a triangular cutout, and situated on one corner of the printed circuit board 642. The slider notch 617 is shown to be shaped generally as a rectangular cutout, and situated along one edge of the printed circuit board 642.

The connector pins 644 are shown to be generally rectangular in shape, and situated along one edge of the printed circuit board 640. The connector pins 644 are formed from conductive metals such as copper, and are used to connect the extended memory card 600 to a host device (not shown) as will be discussed shortly The SD/MMC connector module 646 is shown to be generally rectangular in shape, and include a plurality of SD/MMC connector fingers 648. In an exemplary embodiment, the SD/MMC connector fingers 648 are fabricated from copper or other conductive metals. In an exemplary embodiment of the present invention, the shape, size, and relative position of the SD/MMC connector fingers 648 generally conform to the shape, size, and relative position of connectors in an SD or MMC memory card. In other embodiments, it is anticipated that the SD/MMC connector fingers 648 may be formed according to other standards.

In manufacture, the printed circuit board 642 is formed using commonly available PCB technology. Thereafter, the memory IC 650, controller IC 652, and SD/MMC connector module 646 are affixed to the printed circuit board 642. The connector pins 644 are affixed such that each SD/MMC connector finger 648 is coupled to one connector pin 644. In an exemplary embodiment of the present invention, the memory IC 650 and controller IC 652 are attached to the printed circuit board 642 via surface mount technology (SMT). In other embodiments of the present invention, it is anticipated that other forms of attaching ICs to PCBs may be used. The printed circuit board 642 contains thereon conductive circuitry, for example by way of one or a plurality of associated conductive traces or wires disposed on the printed circuit board 642 or other connection methods known and used in the industry. The conductive circuitry connects the controller IC 652, memory IC 650, connector pins 644, and the USB connection fingers 622 and extended USB connection fingers 634 (shown in FIG. 9).

After the PCBA 612 is attached to the card housing 620 (shown in FIG. 9) the SD/MMC connector fingers 648 are exposed through the SD/MMC connector openings 635 of the card housing 620 (shown in FIG. 9), thus forming the SD/MMC connection fingers 633 (shown in FIG. 9) on the extended memory card 600. The SD/MMC connection fingers 633 and the USB connector 628 allow the extended memory card 600 to advantageously connect to two different host devices (not shown).

The memory IC 650 contains thereon memory circuitry to store data files such as text, images, voice, video, or other data file types. The controller IC 652 is operable to cause the extended memory card 600 to communicate, through either the SD/MMC connection fingers 633 (shown in FIG. 9) or the USB connector 628 (shown in FIG. 9) with the host devices (not shown). The memory, controller, and interface logic and circuitry has been discussed above, and further discussion thereof is avoided in order to eliminate redundancy.

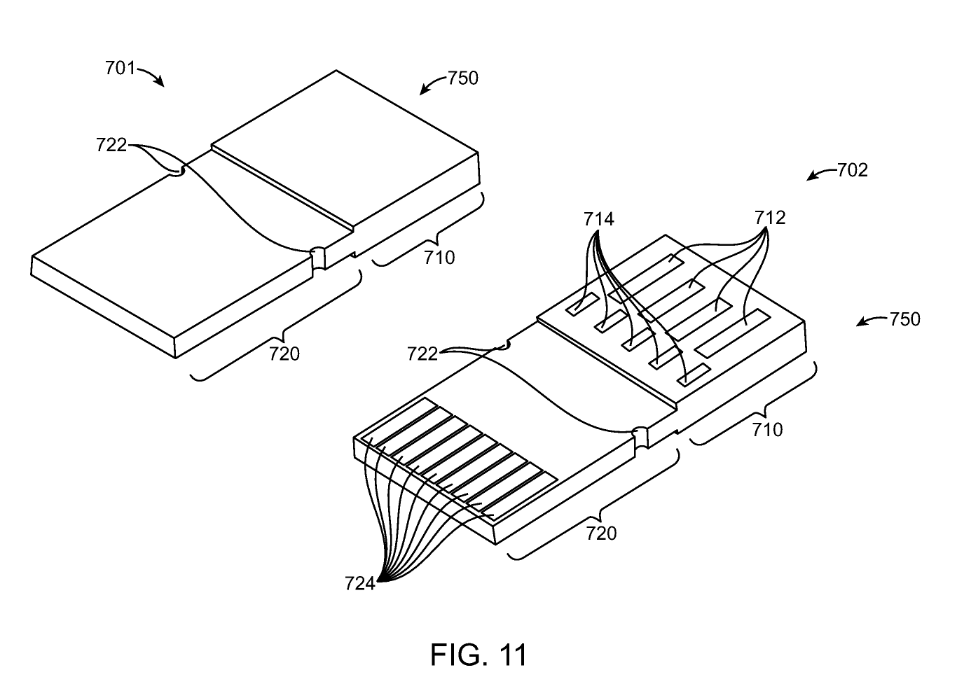

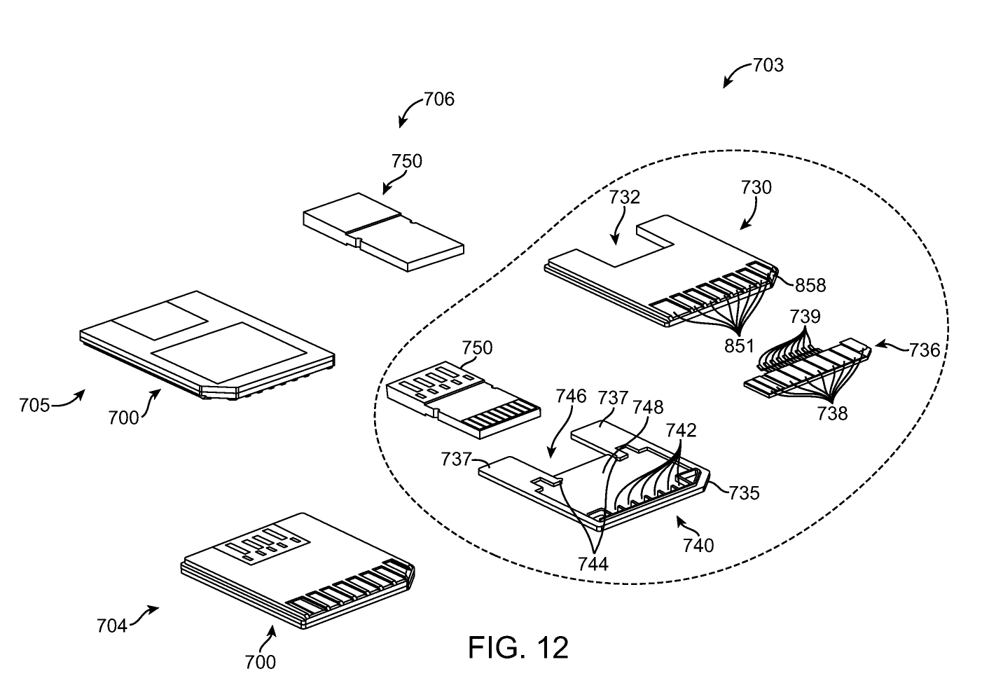

Referring now to FIG. 11, a bottom angular view 701 and a top angular view 702 of a Chip on Board (COB) 750, which is a component of an extended memory card 700 (shown in FIG. 12) is shown according to a different embodiment of the present invention. The bottom view 701 shows the COB 750 to be generally rectangular in form, to contain two side notches 722, and be composed of a thick portion 710 and a thin portion 720. The thick portion 710 is shown to be slightly thicker than the thin portion 720. The side notches 722 are shown situated along the two lengthwise edges of the COB 750 and on the thin portion 720, and are shown to be generally formed as semi-cylindrical cutouts.

The top view 702 shows the COB 750 to include a plurality of SD/MMC connection plates 724 on the thin portion 720. The top view 702 further shows the COB 750 to include a plurality of COB USB connection plates 712 and a plurality of COB extended USB connection plates 714 on the thick portion 710 side. The SD/MMC connection plates 724, COB USB connection plates 712, and the COB extended USB connection plates 714 are all shown to be generally rectangular in shape.

In one embodiment of the present invention, the COB USB connection plates 712, COB extended USB connection plates 714, and SD/MMC connection plates 724 are formed from conducting materials such as copper. In other embodiments, use of other conducting materials is anticipated. In one embodiment of the present invention, the number of the SD/MMC connection plates 724 conform to SD or MMC standards, and the COB 750 is operable to communicate with a host device (not shown) through the SD or MMC standards. It is anticipated that in other embodiments of the present invention, the number of the SD/MMC connection plates 724 conform to other communication standards adopted by the industry at large, and that the COB 750 is operable to communicate with the host device (not shown) through the other standards.

In one embodiment of the present invention, the position, number, and shape of the COB USB connection plates 712 conform to the USB standard, and the COB 750 is operable to communicate with a host device (not shown) through the USB standard. It is anticipated that in other embodiments of the present invention, the shape, position, and number of the SD/MMC connection plates 724 conform to other communication standards adopted by the industry at large, and that the COB 750 is operable to communicate with the host device (not shown) through the other standards.

Furthermore, the COB extended USB connection plates 714, together with the COB USB connection plates 712, allow the COB 750 to communicate with a host (not shown) through an extended USB communication format (extended USB format). In one embodiment of the present invention, the extended USB format is backward compatible with the USB format. The existence of the COB extended USB connection plates 714 allows devices communicating in extended format to transfer data to and from the COB 750 at a higher rate than if the communication was carried out according to USB standard.

The function of the side notch 722 is discussed hereinbelow. It should be noted that in other embodiments of the present invention, the COB 750 does not have a side notch 722.

The COB 750 includes memory and controller circuitry operable to allow the COB 750 to communicate with a plurality of different hosts, as discussed above. In manufacture, the COB 750 is formed through the chip on board (COB) process, discussed above.

Referring now to FIG. 12, an exploded view 703, angular top view 704, and angular bottom view 705 of the extended memory card 700, as well as a bottom view 706 of the COB 750 are shown, according to an embodiment of the present invention. It is noted that the dashed lines are not any part of the structures shown in FIG. 12.

The exploded view 703 of the extended memory card 700 shows the extended memory card 700 to include a top cover 730, a connector module 736, a COB 750, and a bottom cover 740.

The top cover 730 is shown to be generally square in shape, with a COB opening 732, shaped generally as a square cutout on one end, and a plurality of SD/MMC connector openings 851 along the edge thereof on the other end. The SD/MMC connector openings 851 are shown to be generally rectangular cutouts. In an exemplary embodiment, the number, size, shape, and position of the SD/MMC connector openings 851 conform to the number, size, shape, and position of the contact fingers on an MMC or SD card, but in other embodiments, it is anticipated the number, size, shape, and position of the SD/MMC connector openings 851 conform to other standards. The top cover 730 is shown to further include a corner notch 858, shaped generally as a triangular cutout, situated on one corner thereof.

The connector module 736 is shown to be generally rectangular in shape, and include a plurality of SD/MMC connection fingers 738 along one lengthwise edge, and a plurality of COB connection fingers 739 along the opposing lengthwise edge. The SD/MMC connection fingers 738 are shown to be generally square in shape. The COB connection fingers 739 are shown to be generally rectangular in shape. In an exemplary embodiment of the present invention, the SD/MMC connection fingers 738 and COB connection fingers 739 are formed from copper, but in other embodiments, it is anticipated that other conductive metals may be used. The number of the COB connection fingers 739 conforms to the number of SD/MMC connection plates 724 on the COB 750 (shown in FIG. 11). Furthermore, the space between each COB connection finger 739 is such that each COB connection fingers 739 will connect to exactly one SD/MMC connection plate 724, as will be discussed further shortly.

The connector module 736 is fabricated such that each COB connection finger 739 is coupled to one SD/MMC connection finger 738. Furthermore, the space, shape, number, and position of the SD/MMC connection fingers 738 are such that each SD/MMC connection finger 738 will protrude through exactly one SD/MMC connector opening 851.

The bottom cover 740 is shown to be generally square in shape, with a COB opening 746, shaped generally as a square cutout, situated on one end, and a corner notch 735, shaped generally as a triangular cutout, situated on one corner thereof. The bottom cover 740 is further shown to include two raised platforms 737 forming therebetween a central cavity 748. The bottom cover 740 is shown to further include a plurality of chamber cavities 742, shaped generally as square cavities separated by short protrusions, situated on the end opposite to the COB opening 746. Two portions of the raised platforms 737 are shown to extend into the central cavity 748 and towards the COB opening 746, creating two protrusion portions 744.

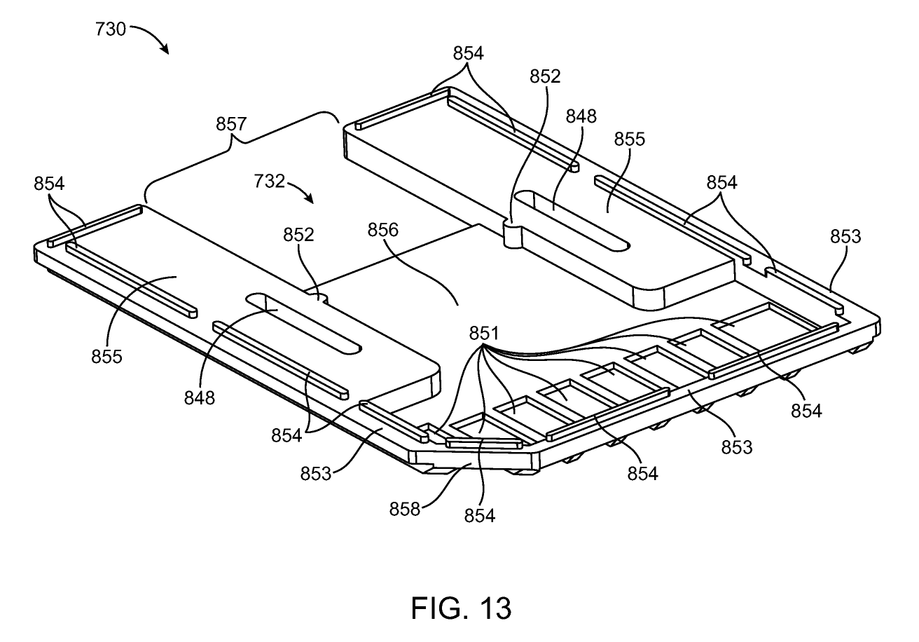

Referring now to FIG. 13, a bottom angular view of a top cover 730, which, in one embodiment of the present invention, is a component of extended memory card 700, is shown with further details, according to an embodiment of the present invention.

The top cover 730 is shown to be generally square in shape, with two raised platforms 855 situated generally on one surface and adjacent to two opposing edges thereof, a central cavity 856 generally in the middle thereof, and a corner notch 858, shown to be generally shaped as a triangular cutout, on a corner adjacent to an edge containing a raised platform 855. In one embodiment of the present invention, the corner notch 858 is shaped generally to conform to the SD or MMC size standards, but it is anticipated that in other embodiments, the corner notch 858 may be shaped to conform to standards of other memory cards or be absent altogether. Shown situated inside the raised platforms 855 are two compression channels 848, shaped generally as linear cutouts in the raised platforms 855.

The top cover 730 is shown to further include an opening 857 situated substantially in the middle of, and along one edge thereof. The opening 857 is shown to be a gap formed by the separation between the two raised platforms 857 and the COB opening 732 in one edge of the top cover 730. The width of the opening 857 is substantially equal to the width of the COB 750 (shown in FIGS. 11 and 12) as will be discussed further hereinbelow.

The top cover 730 is further shown to include a plurality of connector openings 851, shown to be formed generally as rectangular openings, along the edge opposite to the edge containing the opening 732. In one embodiment of the present invention, the shape, position, and number of the connector openings 851 conforms to the shape, position, and number of connectors on an SD/MMC memory card. However, it is anticipated that in other embodiments of the present invention, the connector openings 851 conform to other memory card connector formats.

The top cover 730 is shown to further include raised edges 853 extending along the edge adjacent to the connector openings 851 and extending along the two adjacent edges, and merging with the raised platforms 855. The top cover 730 is shown to further include a plurality of ultrasonic bonders 854, shown to be formed as raised protrusions, narrower in width than the raised edges 853, along three edges, and a portion of a fourth edge. Along the inner edges of the raised platform 855 and facing the central cavity 856 are shown formed a plurality of protrusion posts 852, which are shown to be formed generally as solid, semi-cylindrical protrusions.

In assembly, the COB 750, with its thin portion 720 facing inward and its COB USB connection plates 712, COB extended USB connection plates 714, and SD/MMC connection plates 724 facing up, is placed inside the central cavity 748 of the bottom cover 740, such that the protrusion portions 744 of the bottom cover 740 snap into the side notches 722 of the COB 750, and the thick portion 710 of the COB 750 is generally exposed through the COB opening 746 of the bottom cover 740. The connector module 736, with the SD/MMC connection fingers 738 and the COB connection fingers 739 facing up, is also placed inside the central cavity 748 of the bottom cover 740, such that the chamber cavities 742 firmly hold the connector module 736 in place, and the COB connection fingers 739 of the connector module 736 connect to the SD/MMC connection plates 724 of the COB 750. Thereafter, the top cover 730 is placed on top of the bottom cover, such that the thin portion 720 of the COB 750 is placed inside the center cavity 856 of the top cover 730, the thick portion 710 of the COB 750 is substantially exposed through the COB opening 732 of the top cover 730, and the protrusion posts 852 of the top cover 730 snap into the side notches 722 of the COB 750, and the SD/MMC connection fingers 738 of the connector module 736 are exposed through the SD/MMC connector opening 851 of the top cover 730. In one embodiment of the present invention, the compression channels 848 compress, expanding the central cavity 856 to allow the COB 750 to be firmly held in place. Thereafter, the top cover 730 and bottom cover 740 are ultrasonically bonded together using the ultrasonic bonders 854 of the top cover 730.

As discussed above, the COB extended USB connection plates 714, together with the COB USB connection plates 712, allow the extended memory card 700 to communicate with a host (not shown) through an extended USB communication format (extended USB format). The COB USB connection plates 712 allow the extended memory card 700 to communicate with a host (not shown) through the USB communication format. Furthermore, the SD/MMC connection fingers 738, exposed through the SD/MMC connector openings 851, allow the extended memory card 700 to communicate with host through the SD/MMC format.

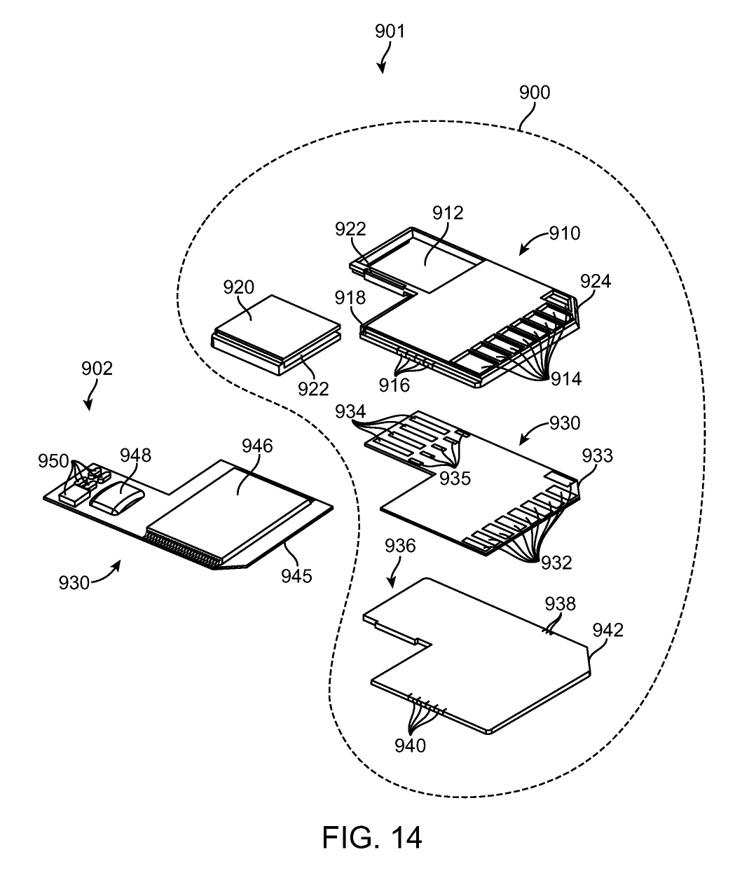

Referring now to FIG. 14, an exploded view of a 901, of an extended memory card 900, and a bottom side angular view 902 of a printed circuit board assembly (PCBA) 930, which is a component of the extended memory card 900, is shown according to a different embodiment of the present invention. It is noted that the dashed lines are not any part of the structures shown in FIG. 14.

The extended memory card 900 is shown to include a top cover 910, a corner cap 920, a PCBA 930, and a bottom cover 936.

The top cover 910 is shown to be generally flat and L-shaped, with a USB connector window 912, shaped generally as a square cutout, on one inside corner thereof. The top cover 910 is shown to further include a plurality of top cover breakaway tabs 916, shaped generally as square tabs, along one lengthwise edge thereof. The top cover 910 is shown to further include a corner notch 924, shown to be formed generally as a triangular cutout, on one corner thereof, and a plurality of SD/MMC connection openings 914, shaped generally as square cutouts, along a widthwise edge adjacent to the corner notch 924. The top cover 910 is shown to further include a connector lip 918, shown generally as a linear protrusion, along one interior edge thereof, and a connector notch 922, shown generally to be a linear indentation, along another interior edge thereof.

The corner cap 920 is shown to be generally square shaped, with a connector notch 922, shown to be shaped generally as a linear notch, along one edge thereof The PCBA 930 is shown to be generally L-shaped, and substantially conform to the shape and dimensions of the top cover 910. The PCBA 930 is shown to include, on one corner thereof, a corner notch 933, shaped generally as a triangular cutout on one corner thereof. The PCBA 930 is shown to further include a plurality of SD/MMC connection fingers 932 situated along one widthwise edge thereof. In one embodiment of the present invention, the SD/MMC connection fingers 932 are formed from copper or other similar conducting materials. The size, shape, and position of the SD/MMC connection fingers 932 are such that they conform to the SD/MMC connection openings 914 of the top cover 910. In the embodiment of the present invention shown in FIG. 14, the size, shape, and position of the SD/MMC connection fingers 932 conform to the size, shape, and position of connectors on an SD or MMC card, but it is anticipated that in other embodiments of the present invention, the size, shape, and position of the SD/MMC connection fingers 932 conform to the connectors in other memory card formats.

The PCBA 930 is shown to further include a plurality of USB connection fingers 934, situated substantially in one row on the widthwise edge thereof opposite to the edge containing the SD/MMC connection fingers. The USB connection fingers 934 are shown to be generally rectangular in shape, and in an exemplary embodiment, are formed from copper or other similar conducting materials. In the embodiment of the present invention shown in FIG. 14, the size, shape, and position of the USB connection fingers 934 conform to the size, shape, and position of connectors on a USB device, but it is anticipated that in other embodiments of the present invention, the size, shape, and position of the USB connection fingers 934 conform to the connectors in other formats.

The PCBA 930 is shown to further include a plurality of extended USB connection fingers 935, which are shown to be generally rectangular in shape. The extended USB connection fingers 935 are shown to be situated substantially in one row, which is generally parallel to the row of the USB connection fingers 934. In one embodiment of the present invention, the extended USB connection fingers 935 are formed from copper or other similar conducting materials. In an embodiment of the present invention, the extended USB connection fingers 935, together with the USB connection fingers 934, communicate with a host device (not shown) in extended USB communication format.

The bottom cover 936 is shown to be generally flat and L-shaped, generally conforming in shape to the top cover 910, and with a corner notch 942, shaped generally as a triangular cutout, on one corner thereof. The bottom cover 936 is shown to further include a plurality of positioning notch tabs 938 along one lengthwise edge thereof, and a plurality of bottom cover breakaway tabs 940 along the opposing edge thereof.

The bottom side angular view 902 of the PCBA 930 shows the PCBA 930 to further include a PCB 945, a memory IC 946, a controller IC 948, and a plurality of electronic components 950. In an exemplary embodiment of the present invention, the memory IC 946, controller IC 948, and electronic components 950 are attached to the PCB 945 using SMT. In other embodiments of the present invention, it is anticipated that other forms of attaching ICs and electronic components to PCBs may be used. The PCB 945 contains thereon conductive circuitry, for example by way of one or a plurality of parallel associated conductive traces or wires disposed on the PCB 945 or other connection methods known and used in the industry. The conductive circuitry connects the memory IC 946, controller IC 948, electronic components 950, USB connection fingers 934, extended USB connection fingers 935, and SD/MMC connection fingers 932.

The memory IC 946 contains therein memory circuitry operable to store data files. The controller IC 948 is operable to enable the extended memory card 900, through either the USB connection fingers 934, extended USB connection fingers 935, or SD/MMC connection fingers 932, to communicate with a host device (not shown) to retrieve data files from the host device, to store said data files on the memory IC 946, and to retrieve data from the memory IC 946 and store the data files onto the host device. The electronic components 950 is operable to connect the controller IC 948 to the memory IC 946. The manner and function of connecting the extended memory card 900 to host devices through various connectors is discussed further hereinabove, and further discussion thereof is avoided to eliminate redundancy.

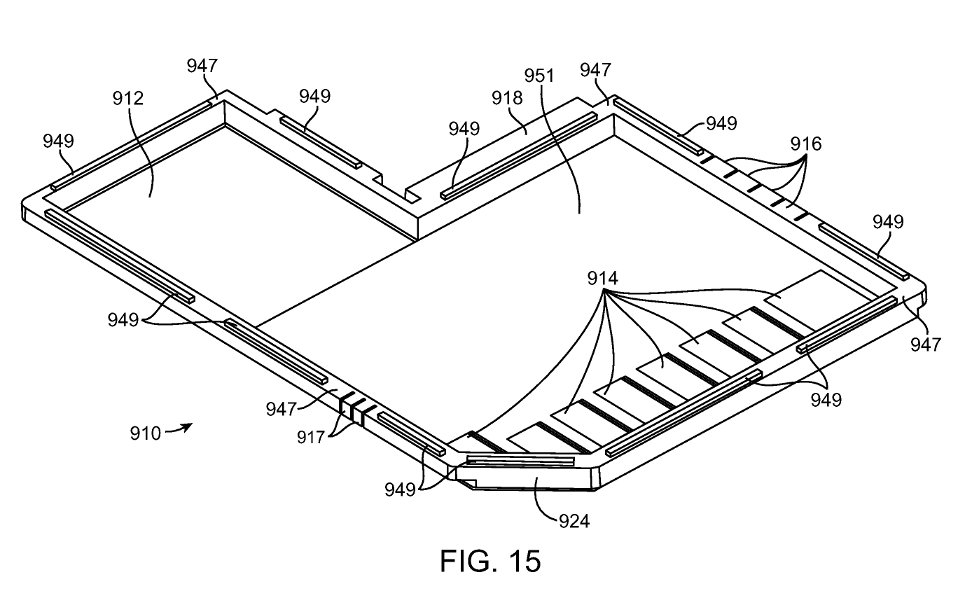

Referring now to FIG. 15, an angular bottom view of the top cover 910 with additional details is shown according to an embodiment of the present invention. The top cover 910 is shown to include plurality of raised sides 947 around the edges thereof, forming therebetween a central cavity 951. Shown formed on top of the raised sides 947 are a plurality of ultrasonic bonders 949, shown herein to be substantially linear protrusions generally narrower than the raised sides 947. The top cover 910 is shown to further include a connector lip 918, generally shaped as a linear protrusion, on one of the edges thereof. The top cover 910 is also shown to include a plurality of positioning notch tabs 917, shaped generally as square tabs, on the edge opposite to the edge on which the top cover breakaway tabs 916 are situated.

In assembly, the PCBA 930 (shown in FIG. 14) is placed inside the top cover 910, such that the USB connection fingers 934 and extended USB connection fingers 935 of the PCBA 930 are exposed through the USB connector window 912, and the SD/MMC connection fingers 932 of the PCBA 930 are exposed through the SD/MMC connection openings 914. Thereafter, the bottom cover 936 (shown in FIG. 14) is ultrasonically joined with the top cover 910, using the ultrasonic bonders 949 of the top cover 910.

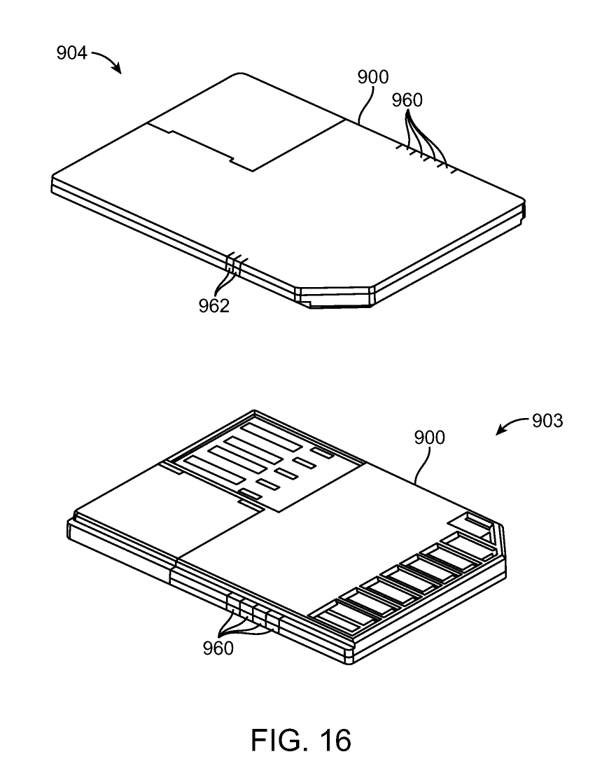

Referring now to FIG. 16, a top angular view 903 and a bottom angular view 904 of the extended memory card 900 is shown according to an embodiment of the present invention. The extended memory card 900 is shown to include a plurality of breakaway tabs 960, formed substantially by the top cover breakaway tabs 916 of the top cover 910 and the bottom cover breakaway tabs 940 of the bottom cover 936. The extended memory card 900 is further shown to include a plurality of positioning tabs 962, formed substantially by the positioning notch tabs 917 of the top cover 910 and the positioning notch tabs 938 of the bottom cover 936. The breakaway tabs 960 and positioning tabs 962 are formed such that a user can break them off by applying pressure thereon.

In one embodiment of the present invention, the extended memory card 900 can connect to an SD/MMC host through the USB connection fingers 934, or to a USB host through the USB connection fingers 934, or to an extended USB host through the USB connection fingers 934 and extended USB connection fingers 935.

Certain SD/MMC host devices include a tab or protrusion to hold an SD/MMC card in place. When connecting to such host devices, users can break off the positioning tabs 962 to create a notch, allowing the tab or protrusion from the host device to snap into the notch, firmly holding the extended memory card 900 in place.

In one embodiment of the present invention, the breakaway tabs 960 are operable to prevent users from accidentally or intentionally deleting, erasing data files from the extended memory card 900, or adding data files to the extended memory card 900. When users are prevented from modifying, deleting, or adding to the data files stored on the extended memory card 900, the extended memory card 900 is deemed “locked.” In one embodiment of the present invention, users lock the extended memory card 900 by breaking some or all of the breakaway tabs 960. In other embodiments of the present invention, users unlock the extended memory card 900 by breaking some or all of the breakaway tabs 960.

What is claimed is:

1. An extended memory card comprising:
memory circuitry;
extended memory controller circuitry;
a plurality of first format connection fingers, and
a plurality of second format connection fingers,
said memory circuitry being operable to store data files therein,
said extended memory controller circuitry being operable to control data file
storage and retrieval to and from said memory circuitry,
wherein said extended memory controller circuitry is further operable to control interface of said extended memory card through either the first format connection fingers or the second format connection fingers with a host device to transfer data files from said host device to be stored on said memory circuitry, and to retrieve data files from said memory circuitry to said host device.

2. An extended memory card as recited in claim 1, wherein said plurality of first format connection fingers are compatible with both the Universal Serial Bus (USB) and extended USB standards, and said plurality of second format connection fingers are compatible with both the secure digital (SD) and multi-media card (MMC) standards.

3. An extended memory card as recited in claim 1, wherein said extended memory card includes a printed circuit board assembly (PCBA) or a chip on board (COB) operable to store said data files, and to communicate with said host device and at least another host device in at least two different formats, and operable to store said data files from said host device or from said at least another host device and to retrieve said data files and transfer said data files to said host device or to said at least another host device.

4. An extended memory card as recited in claim 3, wherein said host device is a USB host and said at least another host device is a secure digital (SD) or multi-media card (MMC) host and said memory circuitry further includes:
extended memory controller;
memory coupled to the controller;
a USB connector;
a SD/MMC connector;
a switch coupled to said memory;
an arbitrator coupled to said switch;
USB interface coupled to said USB connector, said arbitration and to said switch, the USB interface is operable to control the interfacing between said host device and said at least another host device when it is removably coupled to said host device or to said at least another host device; and
SD/MMC interface coupled to said SD/MMC connector, said arbitration and to said switch, the SD/MMC interface is operable to control the interfacing between said host device and said at least another host device when it is removably coupled to said host device or to said at least another host device.

6. An extended memory card as recited in claim 5, wherein said switch is operable to connect the appropriate interface, either the USB interface or the SD/MMC interface, to said memory.

7. An extended memory card as recited in claim 5, wherein the USB interface and the SD/MMC interface are redundantly operative to perform error correction and control of reading and writing data in said memory.

8. An extended memory card as recited in claim 5, further including a controller coupled to said switch and said memory and operative to perform the error correction and control of reading and writing data in said memory.

9. An extended memory card as recited in claim 1, further comprising a protector cap removably attachable to the plurality of first format connection fingers, wherein when said protector cap is attached, said plurality of first format connection fingers are and substantially covered, and when said protector cap is removed said plurality of first format connection fingers are exposed and capable of being coupled with said host device.

10. An extended memory card as recited in claim 1, further comprising a housing, wherein said housing substantially covers and protects the interior of said extended memory card, while leaving said plurality of contact fingers accessible to said host device.

11. An extended memory card as recited in claim 1, further comprising a chip on board (COB) that includes a USB connection pad and said plurality of contact fingers and further includes a housing, wherein said housing is generally T-shaped and includes a corner notch situated on one corner, and a positioning notch situated on one side of said housing, further wherein said housing substantially covers said COB while leaving said plurality of contact fingers accessible to said host device.

12. An extended memory card as recited in claim 1, further comprising a printed circuit board assembly (PCBA) that includes a USB connection pad and said plurality of contact fingers and further includes a housing, wherein said housing is generally T-shaped and includes a corner notch situated on one corner, and a positioning notch situated on one side of said housing, further wherein said housing substantially covers said PCBA while leaving said plurality of contact fingers accessible to said host device.

13. An extended memory card as recited in claim 11, wherein said housing further includes a slider switch operable to lock said extended memory card when said slider switch is moved in one direction, thereby preventing loss of data files, and operable to unlock said extended memory card when said slider switch is moved in the opposite direction.

14. An extended memory card as recited in claim 12, wherein said housing further includes a slider switch operable to lock said extended memory card when said slider switch is moved in one direction, thereby preventing loss of data files, and operable to unlock said extended memory card when said slider switch is moved in the opposite direction.

15. An extended memory card as recited in claim 1, further comprising a bottom cover, wherein breakaway tabs disposed on said bottom cover are operable to break when exposed to user applied pressure, thereby locking said extended memory card and preventing users from accidentally or intentionally deleting, erasing, or adding data files to said extended memory card.

16. An extended memory card comprising:
memory circuitry means;
extended memory controller circuitry means;
a plurality of first format connection finger means, and
a plurality of second format connection finger means,
wherein said memory circuitry means is operable to store data files therein, said extended memory controller circuitry means is operable to control data file storage and retrieval to and from said memory circuitry means, and
wherein said extended memory controller circuitry means is further operable to control interface of said extended memory card through either the first format connection fingers means or the second format connection fingers means with a host device to transfer data files from said host device to be stored on said memory circuitry, and to retrieve data files from said memory circuitry to said host device.

17. An extended memory card as recited in claim 16, wherein said plurality of first format connection fingers means are compatible with both the Universal Serial Bus (USB) and extended USB standards, and said plurality of second format connection fingers means are compatible with both the secure digital (SD) and multi-media card (MMC) standards.

18. An extended memory card as recited in claim 16, wherein said extended memory card includes a printed circuit board assembly (PCBA)or a chip on board (COB) means operable to store said data files, and to communicate with said host device and at least another host device in at least two different formats, and operable to store said data files from said host device or from said at least another host device and to retrieve said data files and transfer said data files to said host device or to said at least another host device.

19. An extended memory card as recited in claim 18, wherein said host device is a USB host and said at least another host device is a secure digital (SD) or multi-media card (MMC) host and said memory circuitry means further includes:
extended memory controller means;
memory coupled to the controller means;
USB connector means;
SD/MMC connector means;
switch means to said memory;
an arbitrator means coupled to said switch;
USB interface means coupled to said USB connector means, said arbitrator means and to said switch means, the USB interface means is operable to control the interfacing between the extended memory card and said USB host device; and
SD/MMC interface means coupled to said SD/MMC connector means, said arbitrator means and to said switch means, the SD/MMC interface means is operable to control the interfacing between the extended memory card and said at least another SD/MMC host device.

20. An extended memory card as recited in claim 19, wherein said switch means is operable to connect the appropriate interface means, either the USB interface means or the SD/MMC interface means, to said memory means.

21. An extended memory card as recited in claim 20, wherein the USB interface means and the SD/MMC interface means are redundantly operative to perform error correction and control of reading and writing data in said memory means.

22. An extended memory card as recited in claim 21, further including a controller means coupled to said switch means and said memory means and operative to perform the error correction and control of reading and writing data in said memory means.

23. An extended memory card as recited in claim 16, further comprising a protector cap means removably attachable to the plurality of first format connection finger means, wherein when said protector cap means is attached, said plurality of first format connection finger means are and substantially covered, and when said protector cap means is removed said plurality of first format connection finger means are exposed and capable of being coupled with said host device.

24. An extended memory card as recited in claim 16, further comprising a housing means, wherein said housing means substantially covers and protects the interior of said extended memory card, while leaving said plurality of contact fingers means accessible to said host device.

25. An extended memory card as recited in claim 16, further comprising a chip on board (COB) means that includes a USB connection pad means and said plurality of contact finger means and further includes a housing means, wherein said housing means is generally T-shaped and includes a corner notch means situated on one corner, and a positioning notch means situated on one side of said housing means, wherein still further said housing means substantially covers said COB means while leaving said plurality of contact finger means accessible to said host device.

26. An extended memory card as recited in claim 16, further comprising a printed circuit board assembly (PCBA) means that includes a USB connection pad means and said plurality of contact finger means and further includes a housing means, wherein said housing means is generally T-shaped and includes a corner notch means situated on one corner, and a positioning notch means situated on one side of said housing means, wherein still further said housing means substantially covers said PCBA means while leaving said plurality of contact finger means accessible to said host device.

27. An extended memory card as recited in claim 25, wherein said housing means further includes a slider switch means operable to lock said extended memory card when said slider switch means is moved in one direction, thereby preventing loss of data files, and operable to unlock said extended memory card when said slider switch means is moved in the opposite direction.

28. An extended memory card as recited in claim 26, wherein said housing means further includes a slider switch means operable to lock said extended memory card when said slider switch means is moved in one direction, thereby preventing loss of data files, and operable to unlock said extended memory card when said slider switch means is moved in the opposite direction.

29. An extended memory card as recited in claim 16, further comprising a bottom cover means, wherein breakaway tab means disposed on said bottom cover means are operable to break when exposed to user applied pressure, thereby locking said extended memory card and preventing users from accidentally or intentionally deleting, erasing, or adding data files to said extended memory card.

30. A method of manufacturing an extended memory card comprising:
positioning a thermal bond adhesive film within a depression disposed on a housing;
positioning a chip on board (COB) within said housing, atop said thermal bond adhesive film;
attaching a protector cap substantially securely within a set of two cap lock grooves disposed on said housing; and
attaching a slider switch substantially securely with the slider mechanism disposed on said housing.

31. A method of manufacturing an extended memory card comprising:
positioning a thermal bond adhesive film within a depression disposed on a housing;
positioning a printed circuit board assembly (PCBA) within said housing, atop said thermal bond adhesive film;
attaching a protector cap substantially securely within a set of two cap lock grooves disposed on said housing; and
attaching a slider switch substantially securely with the slider mechanism disposed on said housing.

32. A method of manufacturing an extended memory card comprising:
positioning a label on the top surface of a printed circuit board assembly (PCBA), said PCBA having substantially the same shape and size of a housing;
attaching a top adhesive film, shaped generally as a narrow band substantially conforming in shape to the outer perimeter of said PCBA, to said housing;
attaching a bottom adhesive film to the general center of said housing; and
positioning said PCBA onto said housing, such that said PCBA is held within said housing substantially securely by said top and said bottom adhesive films.

33. A method of manufacturing an extended memory card comprising:
positioning a chip on board (COB) inside a central cavity of a bottom cover, generally square in shape but with a cutout shaped generally as a smaller square, wherein the one end of COB with a plurality of first format connection fingers disposed thereon, is located inside said cutout;
snapping side notches disposed on said COB into protrusion portions disposed on said bottom cover thereby substantially securing said COB within said bottom cover;
positioning a connector module, on which a plurality of second format connection fingers are disposed thereon, inside said central cavity of said bottom cover; and
positioning a top cover over said bottom cover, thereby substantially enclosing said COB while leaving exposed said plurality of first format connection fingers and said plurality of second format connection fingers.
